(19) United States
(12) Patent Application Publication
(10) Pub. No.: US 2020/0125019 A1
(43) Pub. Date: Apr. 23, 2020

(54) THERMALLY-CONDUCTIVE RUBBER MATERIAL, BELT FOR IMAGE FORMING APPARATUS, AND IMAGE FORMING APPARATUS

(71) Applicant: TOSHIBA TEC KABUSHIKI KAISHA, Tokyo (JP)

(72) Inventors: Osamu TAKAGI, Chofu Tokyo (JP); Hiroshi HASHIZUME, Hino Tokyo (JP)

(21) Appl. No.: 16/721,575

(22) Filed: Dec. 19, 2019

Related U.S. Application Data
(63) Continuation of application No. 15/641,764, filed on Jul. 5, 2017.

(30) Foreign Application Priority Data
Nov. 1, 2016 (JP) 2016-214611

(51) Int. Cl. G03G 15/20

(52) U.S. Cl. CPC G03G 15/2057

(57) ABSTRACT

According to one embodiment, a thermally-conductive rubber material includes silicone rubber, carbon fiber, and spherical graphite. The thermally-conductive rubber material further includes carbon fiber, and the average diameter D of the carbon fiber and the average primary particle diameter R of the spherical graphite satisfy [R/D]≤[1/2].

### CROSS-REFERENCE TO RELATED APPLICATION

This application is a continuation of U.S. patent application Ser. No. 15/641,764, filed on Jul. 5, 2017, which is based upon and claims the benefit of priority from Japanese Patent Application No. 2016-214611, filed Nov. 1, 2016, the entire contents of each are incorporated herein by reference.

### FIELD

Embodiments described herein relate generally to a thermally-conductive rubber material, a belt for an image forming apparatus, and an image forming apparatus.

### BACKGROUND

There exists an image forming apparatus known as a Multi-Function Peripheral (referred to as a “MFP” below) that includes a printer.

The image forming apparatus includes a printer unit configured to form a toner image on a recording medium, and a fixing machine configured to fix the formed toner image onto the recording medium. The fixing machine includes a fixing belt and a press roller which opposes the fixing belt. The fixing belt and the press roller are brought into contact with each other, and thus a nip portion is formed. The recording medium on which the toner image is formed passes through the nip portion, and is heated and pressed. The toner image on the recording medium is melted when the toner image passes through the nip portion, and thus is fixed onto the recording medium.

A toner image of a color electrophotographic image is formed to have multiple layers by using toners of cyan, magenta, yellow, black, and the like. If a heating period of a toner image having multiple layers is short, it is not possible to sufficiently melt a toner, and it is difficult to show desired hue. If the heating temperature of the fixing machine is increased in order to melt the toner by heating for a short period, the toner may be burned, and an offset may occur. If the width of the nip portion of the fixing machine is increased in order to increase the heating period, the size of the fixing machine is increased, and thermal capacity is increased. Thus, energy savings is not achieved.

In the related art, a cushion layer is provided in a fixing belt of a fixing machine, and a contact area between a toner image and the fixing belt is increased. Thus, suppression of an occurrence of image poorness is achieved.

A fixing belt in which a cushion layer includes carbon fiber and an orientation inhibitor for improving thermal conductivity of the fixing belt is known. However, if the carbon fiber is mixed in the cushion layer, flexibility of the cushion layer is reduced.

A fixing belt in which a cushion layer includes a thermally-conductive filler and a microballoon is known. However, if a thermally-conductive filler such as carbon fiber is mixed in the cushion layer, flexibility of the cushion layer is minimized. If the microballoon is mixed in the cushion layer, the strength of the cushion layer is minimized.

### DESCRIPTION OF THE DRAWINGS

FIG. 1 is a side view illustrating a fixing machine according to an embodiment.

FIG. 2 is a sectional view illustrating a fixing belt according to the embodiment.

### DETAILED DESCRIPTION

Embodiments provide a thermally-conductive rubber material which has flexibility and allows improved thermal conductivity, and provides a belt having excellent fixability of a toner and an image forming apparatus.

In general, according to one embodiment, there is provided a thermally-conductive rubber material including silicone rubber, spherical graphite, and carbon fiber. The average diameter D of the carbon fiber and the average primary particle diameter R of the spherical graphite satisfy Expression (1).

[R/D]≤[1/2] Expression (1)

A thermally-conductive rubber material (may be simply referred to as a rubber material below) according to an embodiment includes silicone rubber, spherical graphite, and carbon fiber.

In the rubber material according to the embodiment, spherical graphite and carbon fiber are dispersed in silicone rubber.

The silicone rubber will be described below.

The silicone rubber is not particularly limited, and dimethyl silicone rubber, methyl vinyl silicone rubber, methyl phenyl vinyl silicone rubber, and fluorosilicone rubber are exemplified. The silicone rubber may be singly used or may be used in combination of two types or more thereof.

The content of the silicone rubber in the rubber material is appropriately determined based on the usage and the like of the rubber material.

For example, the content of the silicone rubber with respect to the total amount of the rubber material is 62.5 to 66.7 mass %. If the content of the silicone rubber is equal to or greater than the lower limit value, the strength of the rubber material is further improved. If the content of the silicone rubber is equal to or less than the upper limit value, the content of spherical graphite, which will be described later, is able to be sufficient, and thermal conductivity of the rubber material is more improved.

The spherical graphite will be described below.

The spherical graphite is particles in which an aspect ratio indicated by the major diameter/the minor diameter is 1.0 to 1.5.

The average primary particle diameter R of the spherical graphite is not particularly limited. However, for example, a range of 1 to 40 μm is preferable and a range of 1 to 10 μm is more preferable. If the average primary particle diameter R is equal to or greater than the lower limit value, thermal conductivity is further improved. If the average primary particle diameter R is equal to or less than the upper limit value, flexibility of the rubber material is further improved.

The average primary particle diameter R of the spherical graphite is measured, for example, by a method as follows. A particle group of spherical graphite having a certain amount is observed by an electron microscope (magnified 1,000 to 5,000 times). The major diameters of 100 pieces of spherical graphite in an observation field are measured. An average of the measured major diameters is set as the average primary particle diameter R.

The spheroidized ratio of spherical graphite is not particularly limited. However, for example, the spheroidized ratio thereof is preferably equal to or greater than 80%, more preferably equal to or greater than 90%, further preferably equal to or greater than 94%, and may be 100%. If the spheroidized ratio of the spherical graphite is equal to or greater than the lower limit value, thermal conductivity is further improved. If the spheroidized ratio of the spherical graphite is equal to or greater than the lower limit value, flexibility is also further improved.

The spheroidized ratio of the spherical graphite is a value measured based on Japanese Industrial Standard (JIS) G5502.

The content of the spherical graphite in the rubber material is not particularly limited. The content of the spherical graphite with respect to 100 parts by mass of silicone rubber is preferably 5 to 40 parts by mass. If the content of the spherical graphite is in the above range, thermal conductivity and flexibility are improved more. The content of the spherical graphite with respect to 100 parts by mass of silicone rubber is more preferably 10 to 30 parts by mass. If the content of the spherical graphite is equal to or greater than 10 parts by mass, flexibility and thermal conductivity of the rubber material are further improved. If the content of the spherical graphite is equal to or less than 30 parts by mass, strength of the rubber material is further improved.

Examples of the spherical graphite include WF-15C (Chuetsu Graphite Works Co., Ltd.), SG-BH8 (Ito Graphite Co., Ltd.), SG-BH (Ito Graphite Co., Ltd.), SG-BL30 (Ito Graphite Co., Ltd.), SG-BL40 (Ito Graphite Co., Ltd.), and BELLPEARL (Air Water Bellpearl Inc.). Among these types of spherical graphite, BELLPEARL, having high sphericity, is preferable. These types of spherical graphite may be singly used or may be used in a combination of two types or more thereof.

Carbon fiber will be described below.

A ratio represented by a length/diameter in carbon fiber is more than 1.5.

The average diameter D of carbon fiber is not particularly limited. For example, the average diameter D thereof is preferably 5 to 30 μm and more preferably 5 to 15 μm. If the average diameter D is equal to or greater than the lower limit value, scattering of carbon fiber during mixing occurs less frequently, and handling is easy. If the average diameter D is equal to or less than the upper limit value, thermal conductivity is further improved, and flexibility of the rubber material is further improved.

The average diameter D of carbon fiber is measured, for example, by a method as follows. Carbon fiber having a certain amount is observed by an electron microscope (magnified 1,000 to 5,000 times). The diameters (widths) of 100 pieces of carbon fiber in an observation field are measured. An average of the measured diameters is set as the average diameter of carbon fiber.

The average particle diameter R and the average diameter D satisfy Expression (1).

[R/D]≤[1/2] Expression (1)

The upper limit value of [R/D] is equal to or less than 1/2. If [R/D] is equal to or less than the upper limit value, thermal conductivity is further improved.

The lower limit value of [R/D] is preferably equal to or greater than 1/10. If [R/D] is equal to or greater than the lower limit value, flexibility is further improved.

Examples of carbon fiber include pitch type carbon fiber and polyacrylonitrile (PAN) carbon fiber.

Examples of the pitch type carbon fiber include GRANOC® XN-100-05M and XN-100-15M (Nippon Graphite Fiber Co., Ltd.), DIALEAD® K223QM, K6361M, and K223HM (Mitsubishi Plastics Co., Ltd.), and DONACARBO MIDDLE S-2404, S-249, S-241, and SG-249 (Osaka Gas Chemicals Co., Ltd.).

Examples of the PAN carbon fiber include TORAYCA® MILDFIBER MLD-30, MLD-300, and MLD-1000 (Toray Industries, Inc.) and PYROFIL® CHOPPEDFIBER (Mitsubishi Rayon Co., Ltd.).

The carbon fiber may be singly used or may be used in combination of two types or more thereof.

The content of carbon fiber in the rubber material is not particularly limited. The content of carbon fiber with respect to 100 parts by mass of the silicone rubber is preferably 10 to 60 parts by mass, and more preferably 20 to 50 parts by mass. If the content of carbon fiber is equal to or greater than the lower limit value, conductivity is further improved. If the content of carbon fiber is equal to or less than the upper limit value, flexibility of the rubber material is further improved.

The total amount of spherical graphite and carbon fiber with respect to 100 parts by mass of the silicone rubber is preferably 40 to 100 parts by mass and more preferably 50 to 70 parts by mass. If the total amount of spherical graphite and carbon fiber is equal to or greater than the lower limit value, thermal conductivity of the rubber material is further improved. If the total amount of spherical graphite and carbon fiber is equal to or less than the upper limit value, strength of the rubber material is further improved.

The mass ratio represented by [content of carbon fiber]/[content of spherical graphite] is preferably 1 to 20 and more preferably 1 to 3, for example. If the [content of carbon fiber]/[content of spherical graphite] is equal to or greater than the lower limit value, thermal conductivity is further improved. If the [content of carbon fiber]/[content of spherical graphite] is equal to or less than the upper limit value, flexibility is further improved.

The rubber material in the embodiment may include additives such as a leveling agent (such as siloxane), flaky graphite, a known crosslinking agent, a filler, a conductive agent, rubber, a deterioration inhibitor for a plastic material, and a heat resistance agent, in accordance with the purpose.

The flexibility of the rubber material is indicated by ASKER hardness (hardness) which is measured by a type A durometer based on JIS K6253, for example. For example, the ASKER hardness of the rubber material having a thickness of 2 mm is preferably 60 to 78 and more preferably 65 to 75. If the ASKER hardness of the rubber material is equal to or greater than the lower limit value, flexibility sufficient as a cushion layer of a fixing belt is provided. If the ASKER hardness of the rubber material is equal to or less than the upper limit value, strength of the rubber material is improved.

The thermal conductivity of the rubber material is, for example, preferably equal to or greater than 3 W/mK and more preferably equal to or greater than 4 W/mK. If the thermal conductivity of the rubber material is equal to or greater than the lower limit value, thermal conductivity is excellent.

For example, the rubber material according to the embodiment is used as a cushion layer of a belt in an image forming apparatus. In addition, for example, the rubber material according to the embodiment is used as a surface layer of a press roller in an image forming apparatus. For example, the rubber material according to the embodiment is used as a sealing material requiring heat dissipation.

A belt according to the embodiment will be described below.

The belt according to the embodiment includes a base layer and a cushion layer. The cushion layer is formed by the above-described rubber material in the embodiment. That is, the belt according to the embodiment includes the cushion layer which includes silicone rubber, spherical graphite, and carbon fiber.

Examples of the belt in the embodiment include a fixing belt and a transfer belt for an image forming apparatus. As an image forming apparatus, an image forming apparatus for a color electrophotographic image, and an image forming apparatus for a monochrome electrophotographic image.

An image forming apparatus according to the embodiment includes a belt for forming an image in the above-described embodiment. The image forming apparatus includes a printer unit configured to form a toner image on a recording medium such as a sheet, and a fixing machine configured to fix the toner image to the recording medium.

An example of the fixing machine will be described below.

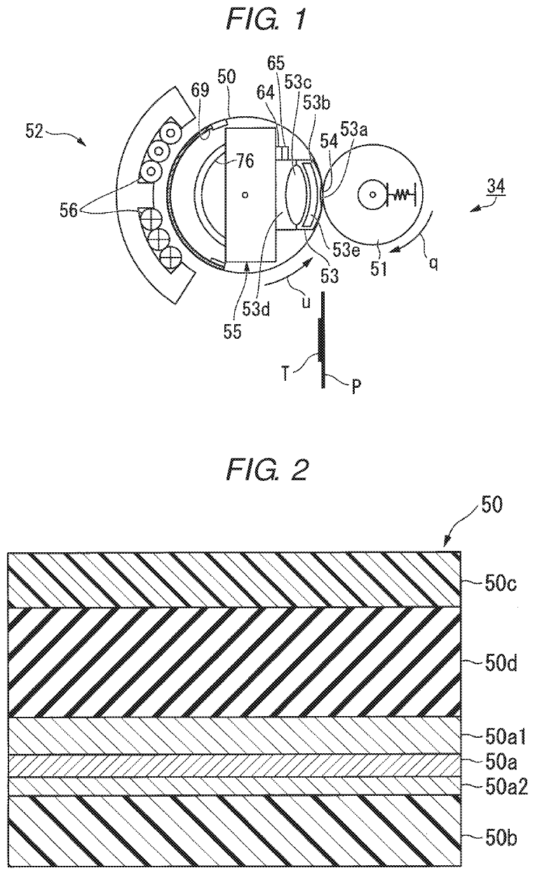

FIG. 1 is a side view illustrating a fixing machine 34.

The fixing machine 34 in FIG. 1 is a fixing machine of an image forming apparatus for a color electrophotographic image.

The fixing machine 34 includes an electromagnetic induction heating coil unit 52. The fixing machine 34 is a device of a fixing type using electromagnetic induction heating (also referred to as “IH” below). The fixing machine 34 is not limited to an IH type fixing machine, and may be a lamp heating type which includes a heating lamp on an inner circumferential side of a fixing belt 50.

As illustrated in FIG. 1, the fixing machine 34 includes a fixing belt 50, a press roller 51, an IH coil unit 52, and a heat generation assistant board 69 (heat assistance member). The fixing belt 50 is a cylindrical endless belt. An inner belt mechanism 55 is disposed on an inner circumferential side of the fixing belt 50. The inner belt mechanism 55 includes a nip pad 53, a frame 53d, a temperature sensor 64, a thermostat 65, and a heat generation assistant board 69. In the embodiment, the fixing belt 50 and the heat generation assistant board 69 come into contact with each other.

The IH coil unit 52 includes a main coil 56.

The fixing belt 50 includes the heat generation assistant board 69 on an inner circumferential portion thereof. In a side surface view, the heat generation assistant board 69 is formed along the inner circumferential surface of the fixing belt 50, so as to have an arc shape. The heat generation assistant board 69 opposes the main coil 56 with the fixing belt 50 interposed between the heat generation assistant board and the main coil.

In the heat generation assistant board 69, both ends having an arc shape are supported by a foundation (not illustrated). An outer side surface of the heat generation assistant board 69 in a diameter direction is in contact with the inner circumferential surface of the fixing belt 50. In the heat generation assistant board 69, both of the ends having an arc shape are supported by the inner belt mechanism 55. The heat generation assistant board 69 is elastically supported. The heat generation assistant board 69 is pressed on the fixing belt 50. Thus, the heat generation assistant board 69 has a structure of being in contact with an inner side of the fixing belt 50.

As illustrated in FIG. 1, a shield 76 is disposed on the inner circumferential side of the heat generation assistant board 69. The shield 76 is formed to have an arc shape, similarly to the heat generation assistant board 69. In the shield 76, both ends having an arc shape are supported by a foundation (not illustrated). The shield 76 may support the heat generation assistant board 69. For example, the shield 76 is formed by a non-magnetic material such as aluminum and copper. The shield 76 blocks magnetic flux from the IH coil unit 52.

The nip pad 53 presses the inner circumferential surface of the fixing belt 50 to the press roller 51 side in the inner circumferential side of the fixing belt 50. A nip portion 54 is formed between the fixing belt 50 and the press roller 51. The nip pad 53 includes a nip formation surface 53a on which the nip portion 54 is formed between the fixing belt 50 and the press roller 51. The nip formation surface 53a is bent so as to protrude to the inner circumferential side of the fixing belt 50 when viewed from a belt width direction.

For example, the nip pad 53 includes a pad main body 53e and a coating layer 53b.

The pad main body 53e is formed by an elastic material such as silicone rubber and fluororubber. The pad main body 53e may be formed by heat resistant resin. Examples of the heat resistant resin include polyimide resin (PI), polyphenylene sulfide resin (PPS), polyethersulfone resin (PES), liquid crystal polymer (LCP), and phenol resin (PF).

The coating layer 53b is formed on a surface opposing the fixing belt 50 in the nip pad 53.

A heat equalizing member 53c is provided on the inner circumferential side of the fixing belt 50. The heat equalizing member 53c is in contact with the nip pad 53. The heat equalizing member 53c is disposed in parallel to a width direction of the fixing belt 50. The heat equalizing member 53c comes into contact with the frame 53d which is parallel to the nip pad 53. The frame 53d is provided on the inner circumferential side of the fixing belt 50 and supports the heat equalizing member 53c. The heat equalizing member 53c is surrounded and fixed by the nip pad 53 and the frame 53d.

As the heat equalizing member 53c, a heat pipe is exemplified.

An example of the fixing belt in the embodiment will be described below.

FIG. 2 is a sectional view illustrating the fixing belt 50.

The fixing belt 50 in FIG. 2 includes a base layer 50b, a heating layer (thermally conductive layer) 50a which is a heating portion, a cushion layer 50d, and a release layer 50c in this order.

For example, the base layer 50b is formed by polyimide resin (PI). Polyimide resin in which metal such as titanium (Ti) is dispersed may be used in the base layer 50b. Metal is dispersed in the base layer 50b, and thus adhesion strength between the base layer 50b and the heating layer 50a is further improved. For example, the base layer 50b may be formed by non-magnetic stainless steel (SUS) in addition to polyimide resin.

The thickness of the base layer 50b is set to be, for example, 50 to 100 μm.

For example, the heating layer 50a may be formed by copper (Cu), nickel, iron (Fe), stainless steel, aluminum (Al), silver (Ag), and the like. The heating layer 50a may use an alloy, and may be formed by layering layers of two types or more of metal.

The heating layer 50a may be a metal-plated layer or may be a metal foil.

The cushion layer 50d is formed by the above-described rubber material in the embodiment. That is, the cushion layer 50d is formed by the rubber material which includes silicone rubber, spherical graphite, and carbon fiber. The average diameter D of carbon fiber included in the cushion layer 50d and the average primary particle diameter R of spherical graphite included in the cushion layer 50d satisfy Expression (1).

[R/D]≤[1/2] Expression(1)

The thickness of the cushion layer 50d is set to be 100 to 400 μm, for example. If the thickness thereof is equal to or greater than the lower limit value, flexibility of the fixing belt 50 is sufficient. If the thickness thereof is equal to or less than the upper limit value, it is possible to prevent the thickness of the fixing belt 50 from being too thick.

For example, the release layer 50c is formed by fluororesin such as tetrafluoroethylene⋅perfluoroalkyl vinyl ether copolymer resin (PFA).

The thickness of the release layer 50c is set to be 5 to 50 μm, for example.

In a case where of a fixing belt in a monochrome image forming apparatus, the release layer 50c may be not included.

The thickness of the heating layer 50a is set to be equal to or less than 10 μm, for example. The thickness of the heating layer 50a is set to be equal to or less than 10 μm, and thus it is possible to reduce thermal capacity of the fixing belt 50.

In the fixing belt 50, the thickness of the heating layer 50a is reduced, and thus the thermal capacity becomes small. The thickness of the heating layer 50a is reduced, and thus a period required for warming-up is reduced, and consumed energy is cut down.

In a case where the fixing machine is a lamp heating type, the fixing belt 50 may not include the heating layer 50a.

Protective layers 50a1 and 50a2 which are formed of nickel and the like are provided on both surfaces of the heating layer 50a, respectively. The protective layers 50a1 and 50a2 suppress oxidation of the heating layer 50a.

The fixing belt 50 may include neither or both of the protective layer 50a1 and the protective layer 50a2.

An example of a manufacturing method of the fixing belt 50 will be described below.

The protective layer 50a2 is formed on the base layer 50b by electroless nickel plating. The surface of the base layer 50b may be roughened by sand blast or chemical etching. The surface of the base layer 50b is roughened, and thus adhesion strength between the base layer 50b and nickel-plating of the heating layer 50a is mechanically further improved.

Then, the heating layer 50a is formed on the protective layer 50a2 by electrolytic nickel plating. Electrolytic nickel plating is performed, and thus adhesion strength between the base layer 50b and the heating layer 50a is improved.

The protective layer 50a1 is formed on the heating layer 50a by electrolytic nickel plating.

The cushion layer 50d configured with the rubber material in the embodiment is formed on the protective layer 50a1. As a method of forming the cushion layer 50d, a forming method as follows is exemplified.

As a first forming method, for example, a silicone rubber composite in which silicone rubber, spherical graphite, and carbon fiber are dispersed in an organic solvent is applied onto the protective layer 50a1. Then, the silicone rubber composite is heated and cured at a certain temperature, thereby the cushion layer 50d is formed.

As a second forming method, silicone rubber, spherical graphite, and carbon fiber are kneaded, thereby a rubber material is obtained. Then, a silicone rubber mixture is formed so as to have a sheet shape. The rubber material in the sheet shape may be cut to size. The sized rubber material sheet is then adhered onto the protective layer 50a1.

The release layer 50c is formed on the cushion layer 50d. As a forming method of the release layer 50c, the known forming method in the related art is exemplified.

An operation of the fixing machine 34 will be described.

As illustrated in FIG. 1, the fixing machine 34 rotates the fixing belt 50 in a direction indicated by an arrow u, during a period when the fixing machine 34 warms up.

A high-frequency current is applied to the main coil 56. The high-frequency current is applied to the main coil 56, and thus a high-frequency magnetic field is generated around the main coil 56. Magnetic flux of the generated high-frequency magnetic field causes an eddy current to flow in the heating layer 50a of the fixing belt 50. The eddy current and electric resistance of the heating layer 50a cause Joule heat (e.g., resistive heating) to be generated in the heating layer 50a. The Joule heat is generated, and thus the fixing belt 50 is heated.

Magnetic flux generated by the main coil 56 causes magnetic flux to be generated between the heat generation assistant board 69 and the fixing belt 50. The generated magnetic flux causes the fixing belt 50 to be heated.

After the fixing belt 50 reaches a fixing temperature, the press roller 51 is butted on the fixing belt 50. If the press roller 51 abuts on the fixing belt 50, the press roller 51 rotates in a direction indicated by an arrow q. The fixing belt 50 is driven and rotated in the direction indicated by the arrow u.

If the image forming apparatus receives a print request, the image forming apparatus starts a print operation. The image forming apparatus causes the printer unit to form a toner image T on a sheet P. The sheet P is, for example, printing paper.

The sheet P on which the toner image T is formed is caused to pass by the nip portion 54. When the sheet P passes by the nip portion 54, toner used for forming the toner image T is heated through the fixing belt 50. The toner heated by the fixing belt 50 is melted. Thus, the toner is fixed to the sheet P.

According to the image forming apparatus in the embodiment, the cushion layer in the fixing belt has high thermal conductivity, and thus it is possible to reduce a time for warming-up.

According to the image forming apparatus in the embodiment, the thermal conductivity of the cushion layer in the fixing belt is high, and flexibility of the cushion layer is not damaged. Thus, the image forming apparatus according to the embodiment can sufficiently heat the toner for a short period, without significantly increasing the heating temperature. In addition, in the image forming apparatus according to the embodiment, it is possible to sufficiently melt the multi-layered toner, and thus it is possible to obtain desired hue and to prevent an occurrence of offset.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

Examples 1-1 to 1-4 and 2-1 to 2-4, and Comparative Examples 1-1 to 1-9 will be described below.

Silicone rubber, carbon fiber (average length: 50 μm, average diameter of 15 μm), and spherical graphite (average primary particle diameter described in Tables) are mixed in accordance with a composition shown in Tables 1 and 2, thereby a silicone rubber composite is prepared. A container having a width of 200 mm, a length of 200 mm, and a depth of 2 mm is filled with the silicone rubber composite. The container filled with the silicone rubber composite is subjected to primary vulcanization and secondary vulcanization at 180° C. to 200° C., thereby a rubber material is obtained. The summation of a period for the primary vulcanization and a period for the secondary vulcanization is 300 minutes.

Regarding the obtained rubber material, thermal conductivity and hardness are measured. The obtained results are shown in Tables.

TABLE 1

| | Composition | | | | | | | |
|---|---|---|---|---|---|---|---|---|
| | Silicone | Carbon | Spherical graphite | | | | | |
| | rubber | fiber | Average | | | | | |
| | Mixing | Mixing | primary | Mixing | | | Measurement results | |
| | amount | amount | particle | amount | | | Thermal | |
| | (part by | (part by | diameter | (part by | Sphericity | | conductivity | |
| | mass) | mass) | (μm) | mass) | (%) | R/D | (W/mK) | Hardness |
| Example 1-1 | 100 | 40 | 2.9 | 10 | 95.8 | 0.19 | 3.9 | 72.3 |
| Example 1-2 | 100 | 40 | 2.9 | 20 | 95.8 | 0.19 | 3.9 | 71.7 |
| Example 1-3 | 100 | 40 | 17.4 | 10 | 93.3 | 1.16 | 4.0 | 72.9 |
| Example 1-4 | 100 | 40 | 17.4 | 20 | 93.3 | 1.16 | 3.0 | 72.5 |
| Example 1-5 | 100 | 40 | 40 | 10 | — | 2.67 | 4.1 | 69.2 |
| Example 1-6 | 100 | 40 | 40 | 20 | — | 2.67 | 4.8 | 73.2 |
| Comparative | 100 | 40 | — | — | — | — | 2.5 | 79.0 |
| Example 1-1 | | | | | | | | |
| Comparative | 100 | 60 | — | — | — | — | 4.3 | 84.8 |
| Example 1-2 | | | | | | | | |
| Comparative | 100 | 80 | — | — | — | — | 2.6 | 87.8 |
| Example 1-3 | | | | | | | | |
| Comparative | 100 | — | 40 | 40 | — | 2.67 | 1.3 | 60.1 |
| Example 1-4 | | | | | | | | |
| Comparative | 100 | — | 40 | 60 | — | 2.67 | 2.2 | 75.2 |
| Example 1-5 | | | | | | | | |
| Comparative | 100 | — | 40 | 80 | — | 2.67 | 3.6 | 81.0 |
| Example 1-6 | | | | | | | | |
| Comparative | 100 | — | 17.4 | 40 | 93.3 | 1.16 | 0.8 | 51.2 |
| Example 1-7 | | | | | | | | |
| Comparative | 100 | — | 17.4 | 60 | 93.3 | 1.16 | 1.0 | 59.2 |
| Example 1-8 | | | | | | | | |
| Comparative | 100 | — | 17.4 | 80 | 93.3 | 1.16 | 1.2 | 64.0 |
| Example 1-9 | | | | | | | | |

TABLE 2

| | Composition | | | | | | | |
|---|---|---|---|---|---|---|---|---|
| | Silicone | Carbon | Spherical graphite | | | | | |
| | rubber | fiber | Average | | | | | |
| | Mixing | Mixing | primary | Mixing | | | Measurement results | |
| | amount | amount | particle | amount | | | Thermal | |
| | (part by | (part by | diameter | (part by | Sphericity | | conductivity | |
| | mass) | mass) | (μm) | mass) | (%) | R/D | (W/mK) | Hardness |
| Example 2-1 | 100 | 40 | 2.9 | 2.5 | 95.8 | 0.19 | 3.3 | 71.9 |
| Example 2-2 | 100 | 40 | 2.9 | 5 | 95.8 | 0.19 | 3.5 | 71.6 |
| Example 2-3 | 100 | 40 | 2.9 | 10 | 95.8 | 0.19 | 3.9 | 72.3 |
| Example 2-4 | 100 | 40 | 2.9 | 20 | 95.8 | 0.19 | 3.9 | 71.7 |

A measuring method of thermal conductivity will be described below.

The rubber material in each of Examples is cut out to have a width 100 mm×length 100 mm×thickness 2 mm, and this is set as a sample. Thermal conductivity of each sample is measured by using a rapid thermal conductivity meter (QTM500 manufactured by Kyoto Electronics Manufacturing Co., Ltd.).

A measuring method of hardness of the rubber material will be described below.

Hardness of the rubber material in each of Examples is measured by a type E durometer.

The measurement is performed by using an ASKER rubber hardness meter E type (http://www.asker.co.jp/products/durometer/analog/e/) with a method defined in JIS K6253 and International Organization for Standardization (ISO) 7619. The thickness of the rubber material to be measured is 2 mm.

As shown in Tables 1 and 2, in all of Examples 1-1 to 1-6 and Comparative Examples 2-1 to 2-4 in which carbon fiber and spherical graphite are provided and R/D is equal to or less than 1/2, thermal conductivity is equal to or greater than 3.0 W/mK. In all of Examples 1-1 to 1-6 and Comparative Examples 2-1 to 2-4, hardness is equal to or less than 75.

In Comparative Examples 1-1 to 1-3 in which spherical graphite is not provided, hardness is equal to or greater than 79. In Comparative Examples 1-4 and 1-5, and 1-7 to 1-9 in which carbon fiber is not provided, thermal conductivity is equal to or less than 2.2 W/mK. In Comparative Example 1-6 in which carbon fiber is not provided and 80 parts by mass of spherical graphite having an average primary particle diameter of 40 μm are provided, thermal conductivity is 3.6 W/mK, but hardness is 81.

What is claimed is:

1. A thermally-conductive rubber material, comprising:
silicone rubber;
carbon fiber within the silicone rubber; and
spherical graphite within the silicone rubber and having a spheroidized ratio of greater than or equal to 80%, wherein
a loading of the carbon fiber is within a range of 10 to 60 parts per 100 parts of the silicone rubber by mass, and
an average diameter D of the carbon fiber and an average primary particle diameter R of the spherical graphite satisfy the following:
R/D≤1/2 and R/D>0.

2. The thermally-conductive rubber material according to claim 1, wherein the average primary particle diameter R is within a range of 1 μm to 40 μm.

3. The thermally-conductive rubber material according to claim 2, wherein a value of a mass ratio, represented by [carbon fiber content]/[spherical graphite content], is within a range of 1 to 20.

4. The thermally-conductive rubber material according to claim 1, wherein a value of a mass ratio, represented by [carbon fiber content]/[spherical graphite content], is within a range of 1 to 20.

5. The thermally-conductive rubber material according to claim 1, wherein a total combined loading of the carbon fiber and the spherical graphite is within a range of 40 to 100 parts per 100 parts of the silicone rubber by mass.

6. A belt for an image forming apparatus, comprising:
a base layer; and
a cushion layer on the base layer and including:
a thermally-conductive rubber material, the thermally-conductive rubber material comprising:
silicone rubber;
carbon fiber within the silicone rubber; and
spherical graphite within the silicone rubber and having a spheroidized ratio of greater than or equal to 80%, wherein
a loading of the carbon fiber in the thermally-conductive rubber material is within a range of 10 to 60 parts per 100 parts of the silicone rubber by mass, and
an average diameter D of the carbon fiber and an average primary particle diameter R of the spherical graphite satisfy the following: R/D≤1/2 and R/D>0.

7. The belt according to claim 6, wherein the average primary particle diameter R is within a range of 1 μm to 40 μm.

8. The belt according to claim 6, wherein a value of a mass ratio, represented by [carbon fiber content]/[spherical graphite content], is in a range of 1 to 20.

9. The belt according to claim 6, wherein a total combined loading of the carbon fiber and the spherical graphite in the thermally-conductive rubber material is within a range of 40 to 100 parts per 100 parts of the silicone rubber by mass.

10. The belt according to claim 6, further comprising:
a thermally conductive layer between the base layer and the cushion layer.

11. The belt according to claim 6, further comprising:
a release layer coupled to the cushion layer.

12. The belt according to claim 6, wherein the thermally-conductive rubber material has an ASKER hardness in a range of 60 to 78.

13. An image forming apparatus, comprising:
a fixing device including:
a belt rotatable about an axis, the belt being adjacent to a heat assistance member, a nip pad being on an inner surface of the belt, and
a coil unit and press roller adjacent to an outer surface of the belt, wherein
the belt comprises a thermally-conductive rubber material comprising:
silicone rubber;
carbon fiber within the silicone rubber; and
spherical graphite within the silicone rubber having a spheroidized ratio of greater than or equal to 80%, wherein
a loading of the carbon fiber in the thermally-conductive rubber material is within a range of 10 to 60 parts per 100 parts of the silicone rubber by mass, and
an average diameter D of the carbon fiber and an average primary particle diameter R of the spherical graphite satisfy the following: R/D≤1/2 and R/D>0.

14. The image forming apparatus according to claim 13, wherein the average primary particle diameter R is within a range of 1 μm to 40 μm.

15. The image forming apparatus according to claim 14, wherein a value of a mass ratio, represented by [carbon fiber content]/[spherical graphite content], is within a range of 1 to 20.

16. The image forming apparatus according to claim 13, wherein the belt further comprises:
a base layer coupled to the thermally-conductive rubber material.

17. The image forming apparatus according to claim 16, wherein the belt further comprises:
a thermally conductive layer between the base layer and the thermally-conductive rubber material.

18. The image forming apparatus according to claim 17, wherein the belt further comprises:
a release layer coupled to the thermally-conductive rubber material.

19. The image forming apparatus according to claim 13, wherein the thermally-conductive rubber material has an ASKER hardness in a range of 60 to 78.

20. The image forming apparatus according to claim 13, wherein a total combined loading of the carbon fiber and the spherical graphite in the thermally-conductive rubber material is within a range of 40 to 100 parts per 100 parts of the silicone rubber by mass.
